(19) United States
(12) Patent Application Publication
(10) Pub. No.: US 2019/0313210 A1
(43) Pub. Date: Oct. 10, 2019

(54) INFORMATION PROCESSING DEVICE, INFORMATION PROCESSING DEVICE CONTROL METHOD, AND CONTROL PROGRAM

(71) Applicant: SHARP KABUSHIKI KAISHA, Sakai City, Osaka (JP)

(72) Inventors: TAKAHIRO OHKAWA, Sakai City (JP); HIROAKI IWAKURA, Sakai City (JP); KIYOTAKA TAKIZUKA, Sakai City (JP)

(73) Assignee: SHARP KABUSHIKI KAISHA, Sakai City, Osaka (JP)

(21) Appl. No.: 16/339,175

(22) PCT Filed: Aug. 24, 2017
(86) PCT No.: PCT/JP2017/030253

§ 371 Date: Apr. 3, 2019

(30) Foreign Application Priority Data
Oct. 7, 2016 (JP) 2016-199414

(51) Int. Cl. H04W 4/029; G06F 16/29

(52) U.S. Cl. CPC H04W 4/029; G06F 16/29

(57) ABSTRACT

The present invention performs visit determination with higher accuracy than in the cases of the conventional techniques. A visit determining section is configured so that in a case where a location of a user (C) indicated by location information has changed from a first location to a second location, the visit determining section determines that the user (C) has made a visit to a facility (P), the first location being included in a visit starting area (D1) which is preset, the second location being excluded from a visit ending area (D2) which is preset. The visit starting area (D1) and the visit ending area (D2) are different.

### TECHNICAL FIELD

Present invention relates to, for example, an information processing device configured to perform information processing by use of location information indicative of the location of a user.

### BACKGROUND ART

In recent years, an information processing device (e.g., mobile terminal) is generally provided with a function to obtain information (location information) indicating a location (current location) of a user with use of a positioning system such as Global Positioning System (GPS). In addition, various types of technique using the location information have been proposed.

For example, Patent Literature 1 discloses a technique intended to determine, with use of location information, the living hours of a user of a mobile terminal. Specifically, according to the technique of Patent Literature 1, the location information and location information retrieval time are used to calculate (i) a period of time for which the user stayed in a certain area (e.g., home area) and (ii) the time at which the user moved between certain areas. The certain area refers to an area containing a certain facility (e.g., home).

### CITATION LIST

### Patent Literature

[Patent Literature 1]

Japanese Patent Application Publication Tokukai No. 2014-2672 (Publication date: Jan. 9, 2014)

### SUMMARY OF INVENTION

### Technical Problem

According to the technique of Patent Literature 1, the set size of the certain area does not vary between (i) a case where it is determined the user has entered the certain area and (ii) a case where it is determined that the user has exited the certain area. That is, the technique of Patent Literature 1 assumes that there are similarities between (i) a movement pattern of the user in a case where the user is moving toward a certain facility (certain location within the certain area) and (ii) a movement pattern of the user in a case where the user is moving away from the certain facility.

However, as described later, it is considered that the above movement patterns are not necessarily similar. In view of this point, it is preferable to consider a difference between the movement patterns (i.e., to consider behavioral patterns of the user according to actual situations) in order to determine, with high accuracy, whether or not the user has visited the certain facility (such determination will be hereinafter referred to as “visit determination”). It is an object of an aspect of the present invention aims to make visit determination with higher accuracy than in the cases of conventional techniques.

### Solution to Problem

In order to attain the object, an information processing device in accordance with an aspect of the present invention is an information processing device including: a location information obtaining section configured to obtain location information which indicates a location of a user; and a visit determining section configured to determine whether or not the user has made a visit to a facility, the visit determining section being configured so that in a case where the location of the user indicated by the location information has changed from a first location to a second location, the visit determining section determines that the user has made the visit to the facility, the first location being included in a visit starting zone which is preset, the second location being excluded from a visit ending zone which is preset, and the visit starting zone and the visit ending zone being different.

In order to attain the object, an information processing device controlling method in accordance with an aspect of the present invention is a method of controlling an information processing device, including the steps of: (a) obtaining location information which indicates a location of a user; and (b) determining whether or not the user has made a visit to a facility, the step (b) further including the step of determining, in a case where the location of the user indicated by the location information has changed from a first location to a second location, that the user has made the visit to the facility, the first location being included in a visit starting zone which is preset, the second location being excluded from a visit ending zone which is preset, and the visit starting zone and the visit ending zone being different.

### Advantageous Effects of Invention

An information processing device in accordance with an aspect of the present invention brings about such an effect as being able to make visit determination with higher accuracy than in the cases of conventional techniques.

An information processing device control method in accordance with an aspect of the present invention brings about an effect similar to that of the information processing device.

### BRIEF DESCRIPTION OF DRAWINGS

FIG. 1 is a functional diagram illustrating a configuration of main parts of a mobile terminal in accordance with Embodiment 1 of present invention.

(a) through (d) of FIG. 2 are a set of views illustrating an overview of a process of visit determination carried out by the mobile terminal illustrated in FIG. 1.

FIG. 3 is a view illustrating a facility database.

FIG. 4 is a view illustrating a genre code correspondence table.

FIG. 5 is a view illustrating a visiting history.

FIG. 6 is a view illustrating an image displayed on a screen of a display section of the mobile terminal illustrated in FIG. 1.

FIG. 7 is a view illustrating a flow of the process of the visit determination carried out by the mobile terminal illustrated in FIG. 1.

FIG. 8 is a view illustrating a visit starting area and a visit ending area used by a mobile terminal in accordance with Embodiment 2 of the present invention.

### DESCRIPTION OF EMBODIMENTS

### Embodiment 1

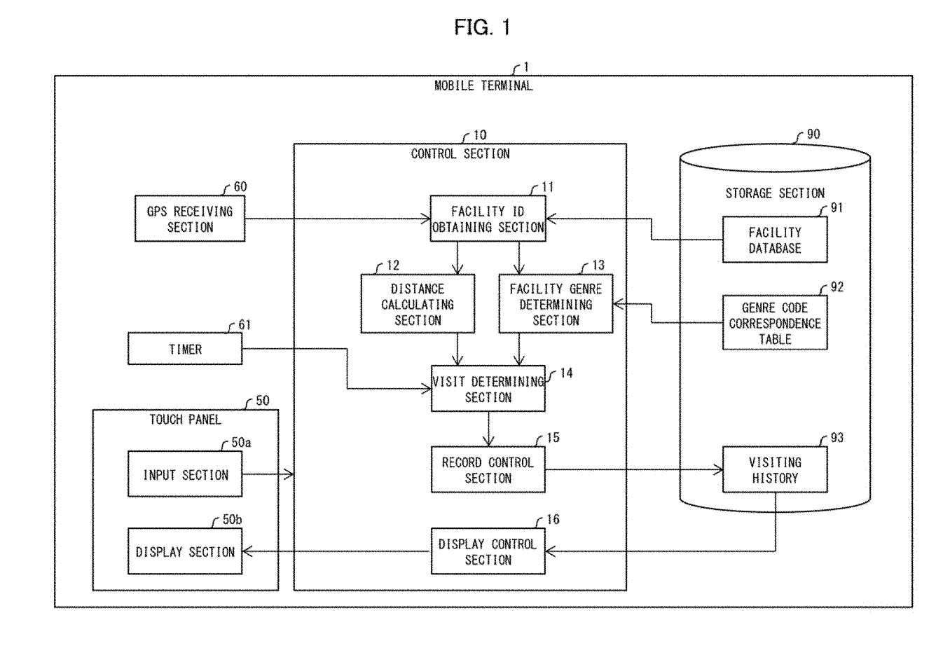

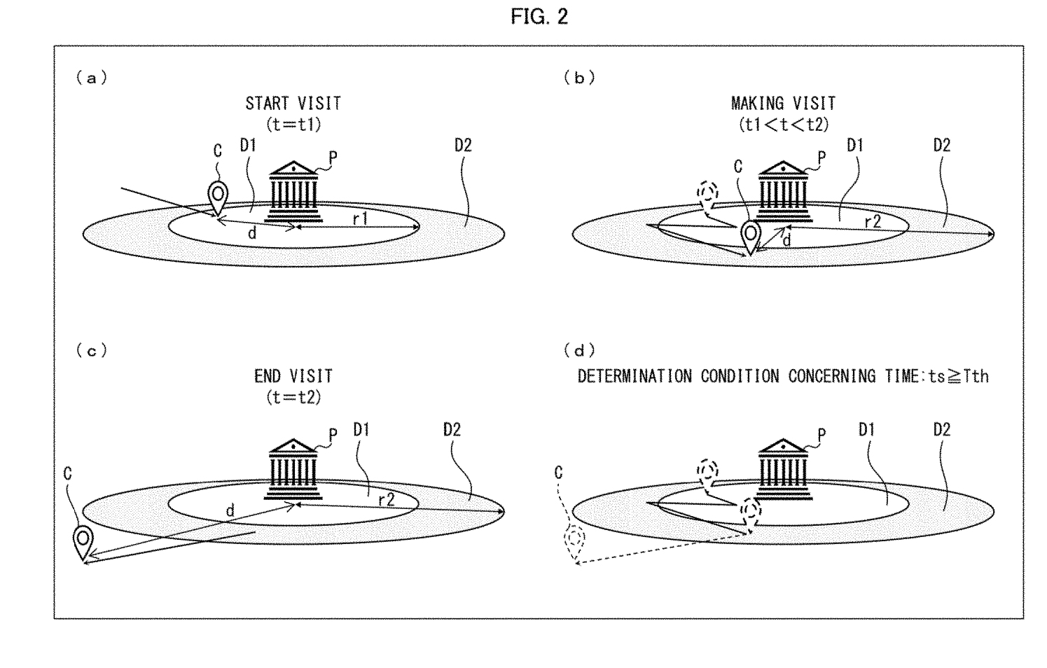

The following description will discuss Embodiment 1 of the present invention in detail with reference to FIGS. 1 through 7. An overview of a mobile terminal 1 (information processing device) in accordance with Embodiment 1 will be described first with reference to FIG. 1. FIG. 1 is a functional diagram illustrating a configuration of main parts of the mobile terminal 1. In Embodiment 1, the mobile terminal 1 is a smartphone (mobile phone).

Note, however, that the information processing device in accordance with an aspect of the present invention is not limited to a mobile phone. Other examples of the information processing device encompass any portable information processing devices (mobile terminals) such as a laptop PC (Personal Computer), a tablet PC, and a portable television. Alternatively, as a described later, the information processing device in accordance with an aspect of the present invention can be a server connectable to the mobile terminal.

(Overview of Mobile Terminal 1)

The mobile terminal 1 includes a control section 10, a touch panel 50, a GPS receiving section 60, a timer 61, and a storage section 90. The touch panel 50 is a member in which the input section 50a and the display section 50b are superimposed and integrated. Alternatively, the information processing device in accordance with an aspect of the present invention can be configured so that the input section 50a and the display section 50b are provided separately.

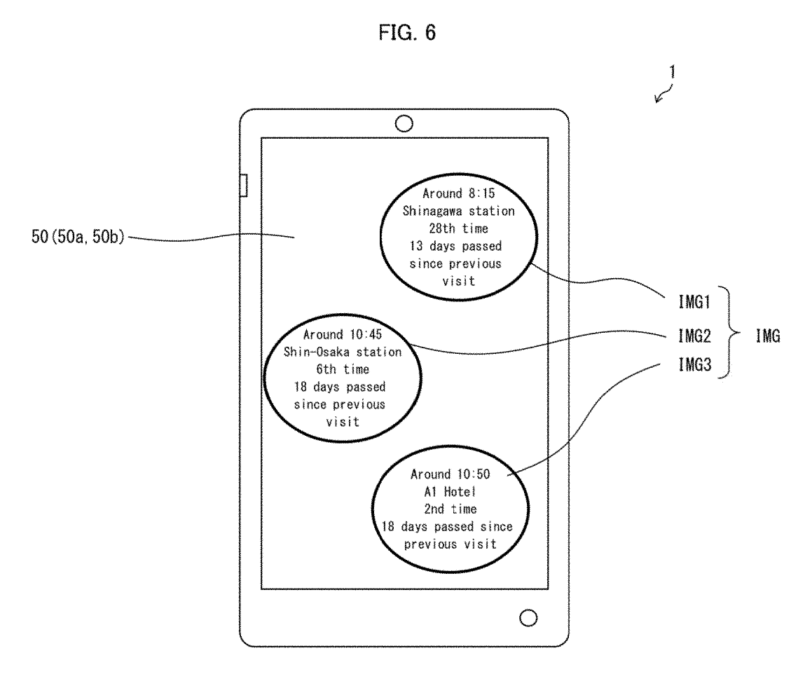

The input section 50a accepts an input operation of a user. For example, the input section 50a accepts the input operation (touch operation) of the user by detecting that an object (e.g., a finger of the user) has come into contact with the input section 50a. The display section 50b can be, for example, a liquid crystal display. The display section 50b displays various types of information as images. The display section 50b serves as a notifying section configured to visually notify the user of various types of information (see FIG. 6 described later).

However, the information processing device in accordance with an aspect of the present invention does not necessarily need to have the display section 50b. For example, the display section 50b can be provided as a member which is separated from the information processing device. In a case where the information processing device is able to communicate with the display section 50b, an operation of the display section 50b can be controlled by a display control section 16 described later.

The GPS receiving section 60 receives a GPS signal transmitted as a radio wave from a satellite or the like, so as to obtain location information indicating a location (current location) of the user carrying the mobile terminal 1. The GPS receiving section 60 provides the location information to the control section 10 (more specifically, to the facility ID obtaining section 11 described later).

The timer 61 measures current time. The timer 61 can also measure an amount of time elapsed from certain time. The timer 61 can be provided, as a designated device, in the mobile terminal 1. Alternatively, a timer function in a sensor microcomputer of the mobile terminal 1 can be used as the timer 61. The timer 61 provides results of time measurement to the control section 10 (more specifically, to a visit determining section 14 described later).

The control section 10 centrally controls the sections of the mobile terminal 1. The function of the control section 10 can be achieved by controlling the Central Processing Unit (CPU) to execute a program stored in the storage section 90. An operation of the control section 10 will be described in detail later.

The storage section 90 stores (i) various programs to be executed by the control section 10 and (ii) data to be used by the programs. Embodiment 1 will discuss an example in which the storage section 90 stores a facility database 91, a genre code correspondence table 92, and a visiting history 93 (described later).

Note, however, that at least one of the facility database 91, the genre code correspondence table 92, and the visiting history 93 can be stored in a server (e.g., cloud server) which is connectable to the mobile terminal 1 by a known communication technology (e.g., wireless LAN technology).

In addition, at least part of the functions of the control section 10 (e.g., the function of the visit determining section 14) can be imparted to the server. That is, the server can be used as an information processing device in accordance with an aspect of the present invention.

The number of servers used as the information processing device can be one or more. In a case where a plurality of servers are applied, the servers can be managed by a business operator or managed by a different business operators.

(Overview of Process of Visit Determination Carried Out by Mobile Terminal 1)

FIG. 2 is a view illustrating an overview of a process of visit determination carried out by the mobile terminal 1. Prior to describing the specific operation of the control section 10 (specific flow of the process of the visit determination), the overview of the process will be described with reference to FIG. 2. The following will describe an example in which a user C moves toward a facility P (visiting subject candidate facility (described later)) and then moves away from the facility P.

(a) of FIG. 2 shows a case where the user C starts a visit to the facility P. Specifically, (a) of FIG. 2 shows a case where the user C enters the visit starting area D1 (visit starting zone) described below. As illustrated in (a) of FIG. 2, the visit starting area D1 is a circular area having a radius r1 (hereinafter, “r1” will also be referred to as “visit starting radius”) in which area the facility P is centered. The value of r1 is set in advance. That is, the visit starting area D1 is set in advance.

As described later, in a case where the user C enters the visit starting area D1, the mobile terminal 1 determines that the user C has started a visit to the facility P. That is, the mobile terminal 1 starts visit determination when the condition d≤r1 (hereinafter referred to as “starting condition”) is satisfied. Note that d is a distance between the user C and the facility P. Hereinafter, the time at which the user C enters the visit starting area D1 will also be referred to as “visit start time t1”.

(b) of FIG. 2 shows a case where the user C continues the visit to the facility P after the (visit start) state illustrated in (a) of FIG. 2. More specifically, in (b) of FIG. 2, the user C is located in a visit ending area D2 (also referred to as “visit ending zone”) described below. As illustrated in (b) of FIG. 2, the visit ending area D2 is a circular area having a radius r2 (hereinafter, “r2” will also be referred to as “visit ending radius”) in which area the facility P is a centered). The value of r2 is also set in advance in a manner similar to that of r1 described above. That is, the visit ending area D2 is set in advance in a manner similar to that of the visit starting area D1 described above.

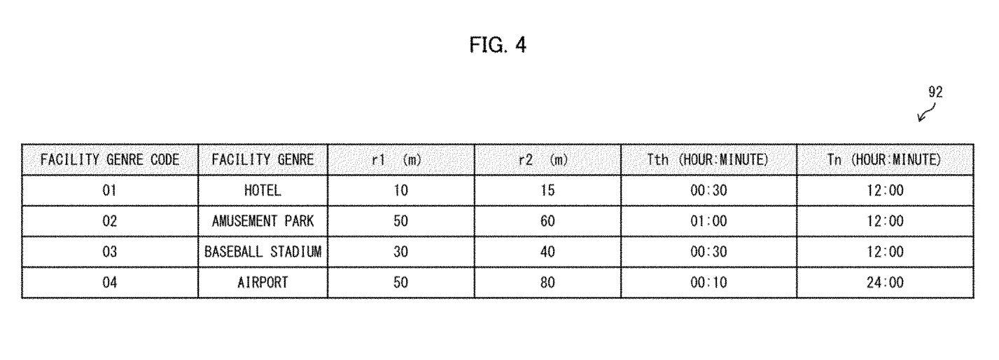

However, as described later, r2 is set to a value differing from r1. That is, the visit ending area D2 is set as an area that differs from the visit starting area D1. According to Embodiment 1, r2 is set to a value greater than r1, as also illustrated in FIG. 4 described later. That is, the visit ending area D2 is set to be wider than the visit starting area D1. The “size” of each area in Embodiment 1 means a surface area.

In a case where the user C is located in the visit ending area D2 after the starting condition described above is satisfied, the mobile terminal 1 determines that the user C is making the visit to the facility P. That is, in a case where the condition “d≤r2” is satisfied (i.e., until an ending condition described later is satisfied), the mobile terminal 1 determines that user C is making the visit to the facility P.

(c) of FIG. 2 shows a case where the user C has ended the visit to the facility P after the state illustrated in (b) of FIG. 2 (where the visit was being made). Specifically, (c) of FIG. 2 shows the case where the user C has exited the visit ending area D2.

In a case where the user C exits the visit ending area D2, the mobile terminal 1 determines that the user C has finished the visit to the facility P. That is, in a case where the condition “d>r2” (hereinafter, ending condition) is satisfied, the mobile terminal 1 determines that the user C has finished the visit to the facility P. Hereinafter, the time at which the user C exits the visit ending area D2 will also be referred to as visit end time t2. As described above, the starting condition and the ending condition are determination conditions concerning space (distance). Hereinafter, the starting condition and the ending condition will also be collectively referred to as “spatial conditions”.

(d) of FIG. 2 is a view illustrating a determination condition concerning time (hereinafter also referred to as “time condition”) in visit determination. The mobile terminal 1 calculates a difference between the visit end time t2 and the visit start time t1 as a stay period ts. That is, the mobile terminal 1 calculates the stay period ts where ts=t2−t1.

In a case where the condition (time condition) “ts≥Tth” is satisfied, the mobile terminal 1 determines that the user C has made the visit to the facility P. Note that “Tth” will also be referred to as “stay period threshold”. The value of Tth is also set in advance in a manner similar to those of r1 and r2 described above.

As described above, the mobile terminal 1 performs visit determination by use of both the spatial conditions (the starting condition and the ending condition) and time condition. Note that the expression “spatial conditions” can be conditions indicating “whether or not the user C has moved to enter the visit starting area D1 and then exit the visit ending area D2”. In addition, the time condition can be expressed as a condition indicating whether or not a time period in which the spatial conditions are satisfied is within a certain time range.

(Control Section 10)

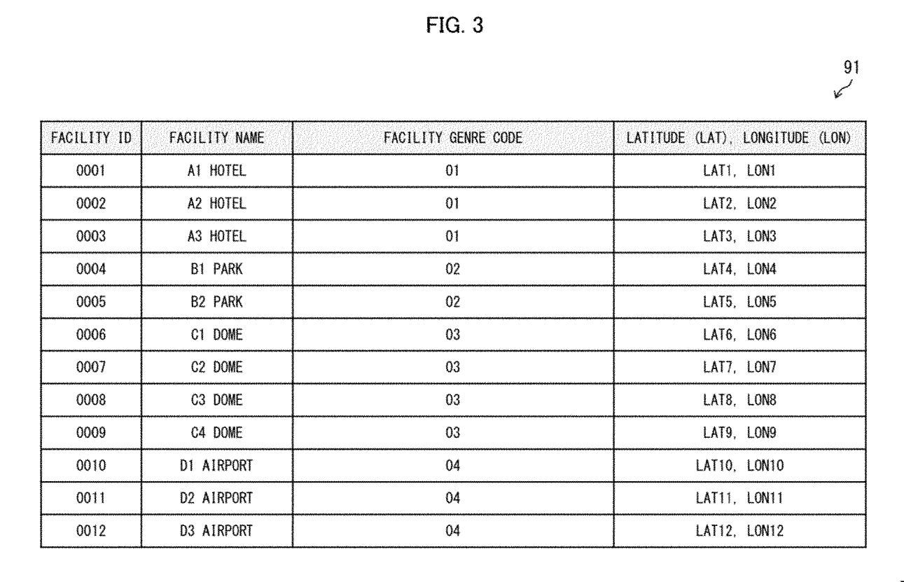

As illustrated in FIG. 1, the control section 10 includes the facility ID obtaining section 11 (location information obtaining section), a distance calculating section 12, a facility genre determining section 13 (determination condition setting section), the visit determining section 14, a record control section 15, and the display control section 16. A specific operation of each section will be described below. With respect to FIGS. 3 through 5, concrete examples of the facility database 91, the genre code correspondence table 92, and the visiting history 93 will also be described.

The facility ID obtaining section 11 obtains location information (information indicating the location of a user) from the GPS receiving section 60. Embodiment 1 discusses an example in which the facility ID obtaining section 11 is provided with the function of a location information obtaining section. However, the facility ID obtaining section 11 and a location information obtaining section can be provided as separate functional sections.

For example, location information can be represented by a latitude (hereinafter represented by a symbol “LAT”) and longitude (hereinafter represented by a symbol “LON”). That is, the location information can be coordinates indicating the location of point on a two-dimensional coordinates defined by the latitude and the longitude. In the following example, the location information represents coordinates c (LATc, LONc).

The facility ID obtaining section 11 obtains the facility database 91 from the storage section 90. FIG. 3 is a view illustrating the facility database 91. As illustrated in FIG. 3, the facility database 91 is a table showing various pieces of information (e.g., a name (facility name), a facility genre code (facility genre identification information), and coordinates (location) on a corresponding facility ID (facility identification information).

Note that a facility ID is identification information for identifying each facility. Facility IDs are assigned different numbers (values) for each facility. A facility genre code is identification information (classification code) for identifying the type of each facility (also referred to as “facility genre”). Facility genre codes are assigned different numbers for each facility genre (see FIG. 4 in described later).

The facility database 91 can be preset by the manufacturer of the mobile terminal 1. Alternatively, a Point of Interest (POI) database provided by a business operator other than the manufacturer of the mobile terminal 1 can be utilized as the facility database 91.

Subsequently, the facility ID obtaining section 11 compares the location information with the facility database 91 to search for facilities in the vicinity of the user. Then, the facility ID obtaining section 11 obtains facility IDs and the like of the facilities detected (hit as search results). Hereinafter, a facility/facilities detected by the facility ID obtaining section 11 will also be referred to as “visiting subject candidate facility/facilities”. According to Embodiment 1, it is assumed that the facility P (one facility) illustrated in FIG. 2 is a visiting subject candidate facility.

In this example, the facility ID obtaining section 11 has detected, as the facility P, a facility located at coordinates p1 (LAT1, LON1), that is, A1 hotel. In this case, the facility ID obtaining section 11 refers to the facility database 91 and obtains (i) the facility ID “0001” of the facility P, and (ii) the facility names “A1 hotel” and the facility genre code “01” which are associated with the facility ID “0001”.

For example, the facility ID obtaining section 11 can search for a facility which is located within a certain range from coordinates c. For example, the facility LID obtaining section 11 can set, as a search area (i.e., an area in which the facility is searched for), a circular area whose center is the coordinates c and which has a radius rm. The value of rm can be any value. For example, a maximum value of a plurality of set values of the visit starting radius r1 can be used as the value of rm. For example, in a case where a plurality of values of the visit starting radius r1 are set as illustrated in FIG. 4 described later, rm can be set to 50 m.

Alternatively, the facility ID obtaining section 11 can set, as a search area, an area (rectangular area) having a latitude and a longitude within a certain range from the coordinates c. In any of the cases, however, it is preferable to set a search area to be narrow to some extent in order to avoid an increase in search time.

The distance calculating section 12 obtains, from the facility ID obtaining section 11, (i) the coordinates c (location information) and (ii) coordinates p (information indicating the location of facility P) (hereinafter also referred to as “facility location information”). Then, the distance calculating section 12 uses the coordinates c and the coordinates p1 to calculate the distance d. For example, the distance calculating section 12 can calculate the distance d as represented by the following formula:

d=sqrt{(LATc−LAT1)\hat{ }2+(LONc−LON1)\hat{ }2}

The facility genre determining section 13 obtains the facility genre code of the facility P from the facility ID obtaining section 11. For example, the facility genre determining section 13 obtains a facility genre code “01” associated with the facility ID “0001” of the facility P (A1 hotel).

The facility genre determining section 13 obtains the genre code correspondence table 92 from the storage section 90. As described below, the genre code correspondence table 92 is a table showing determination parameters (threshold in the visit determination described above) associated with the facility genre codes (in other words, the facility genres).

FIG. 4 is a view illustrating the genre code correspondence table 92. As illustrated in FIG. 4, the genre code correspondence table 92 shows the facility genres represented by the respective facility genre codes. For example, in FIG. 4, the facility genre code “01” represents the facility genre “hotel”.

In addition, in the genre code correspondence table 92, the following are associated with each of the facility genre codes: (i) r1 (visit starting radius) described above, (ii) r2 (visit ending radius) described above, (iii) Tth (stay period threshold), and (iv) Tn (re-determination possible period threshold) described later. That is, r1, r2, Tth, and Tn are set in the mobile terminal 1 for each facility genre.

For example, with respect to the facility genre “hotel” (facility genre code “01”), (i) r1 is set to a value of 10 m, (ii) r2 is set to a value of 15 m, (iii) Tth is set to a value of 00:30 (30 minutes), and (iv) Tn is set to a value of 12:00 (12 hours). Meanwhile, with respect to the facility genre “amusement park” (facility genre code “02”), (i) r1 is set to a value of 50 m, (ii) r2 is set to a value of 65 m, (iii) Tth is set to a value of 01:00 (1 hour), and (iv) Tn is set to a value of 12:00 (12 hours).

The information processing device in accordance with an aspect of the present invention can be configured so that r1, r2, Tth, and Tn are each set to an identical value for all of the facility genres (in other words, all of the facilities). However, in order to improve the accuracy of visit determination, it is preferable to perform visit determination according to each facility genre. It is therefore preferable that at least one of r1, r2, Tth, and Tn is set to different values for the respective facility genres.

The facility genre determining section 13 compares the facility genre code of the facility P with the genre code correspondence table 92 to determine the facility genre of the facility P. For example, in a case where the facility genre code of facility P (A1 hotel) is “01”, the facility genre determining section 13 determines that the facility genre of facility P is “hotel” (facility genre corresponding to facility genre code “01”).

Then, the facility genre determining section 13 obtains, from the genre code correspondence table 92, the respective values of r1, r2, Tth, and Tn set for the facility genre thus determined. The facility genre determining section 13 can thus set (select) determination parameters according to each facility genre. Specifically, the facility genre determining section 13 can set, according to each facility genre, (i) the size of the visit starting area D1, (ii) the size of the visit ending area D2, and (iii) the length of the stay period threshold. The facility genre determining section 13 can thus set, according to facility genre, the determination criteria for the spatial conditions and the time condition described above.

The visit determining section 14 is configured to (i) obtain the distance d from the distance calculating section 12 and (ii) obtain the current time t from the timer 61. Then, the visit determining section 14 determines, with use of the determination parameters set by the facility genre determining section 13, whether or not the user has made a visit to the facility P. That is, the visit determining section 14 performs, by use of the above determination parameters, the visit determination described in FIG. 2. A concrete example of a determination process carried out by the visit determining section 14 will be discussed later. In addition, the visit determining section 14 transmits, to the record control section 15, determination result information indicating the determination result.

The record control section 15 controls the process to recording data from the control section 10 in the storage section 90. For example, in a case where the visit determining section 14 has determined that “the user has made the visit to the facility P” (i.e., the determination result information indicates that the user has made the visit to the facility P), the record control section 15 writes a record of the visit as a visiting history into the visiting history 93 (i.e., updates the visiting history 93). Since the record control section 15 can automatically update the visiting history 93, the convenience of the user can be improved. An example of the process carried out by the record control section 15 will also be described later.

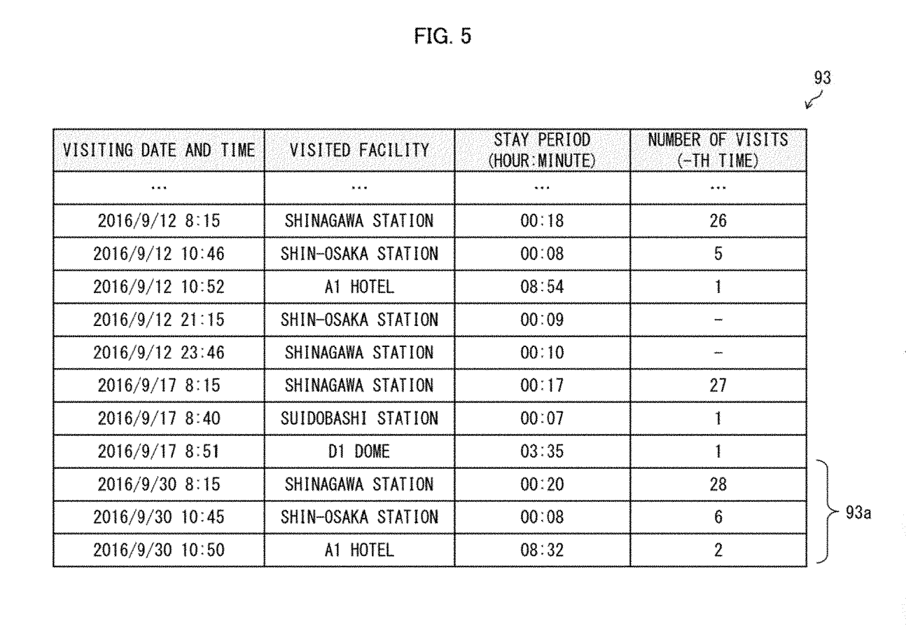

FIG. 5 is a view illustrating the visiting history 93. As illustrated in FIG. 5, history information (visiting dates and times, visited facilities, stay periods, and numbers of visits) indicating each visit is recorded in the visiting history 93. Note that the record control section 15 counts up (sums up) the number of visits to the facility once each time a new visit to the same facility is determined (see, for example, the visited facility “A1 hotel” of FIG. 5).

The symbol “-” in the “number of visits” column of FIG. 5 indicates that a visit(s) has been excluded from the counting of the number of visits. For example, in a case where the user makes a round trip on a certain path by train, it is conceivable that the user would visit the same station in each of an outward trip and a return trip. It is therefore possible to configure the determining section 14 to exclude, from a target of visit determination, a visit to the station on the return trip. A specific determination process for such exclusion will be described later.

The display control section 16 controls the operation of display section 50b. For example, the display control section 16 can control the display section 50b to display, as an image, at least part of a visiting history (hereinafter referred to as “display-use history 93a”). For example, the display control section 16 can control the display section 50b to display, as the display-use history 93a, today's history information included in the visiting history 93. FIG. 5 shows the display-use history 93a in a case where today's date is “2016 Sep. 30”.

FIG. 6 is a view illustrating an image displayed on a screen of the display section 50b. Specifically, FIG. 6 shows that the display-use history 93a is images IMG1 through IMG3. Note that the images IMG1 through IMG3 can be collectively referred to as “image IMG”. The display control section 16 generates the image IMG (images IMG1 through IMG3) based on respective pieces of the history information in the visiting history 93.

In FIG. 6, the image IMG1 indicates a visiting history of a visit to “Shinagawa station” at “2016 Sep. 30 8:15” in the display-use history 93a. The image IMG2 indicates a visiting history of a visit to “Shin-Osaka station” at “2016 Sep. 30 10:45” in the display-use history 93a. The image IMG3 indicates a visiting history of a visit to “A1 hotel” at “2016 Sep. 30 10:50” in the display-use history 93a.

As illustrated in FIG. 6, for example, the IMG1 shows that the current visit to Shinagawa station is the “28th” visit and that 13 days elapsed from the previous visit until today (current visit). The display control section 16 can thus include the following information (i) and (ii) in an image IMG: (i) information indicating the number of visits to a certain facility and (ii) information indicating the number of days elapsed from the date of the previous visit to the certain facility until today.

The display section 50b is thus controlled to display at least part of the visiting history as an image IMG. This makes it possible to visually notify a user of the content of the visiting history. That is, the user can easily confirm the content of the visiting history.

According to the input operation of the user, the display control section 16 can change the image to be displayed by the display section 50b. For example, according to the input operation, the display control section 16 can control the display section 50b to display, as part of the display-use history 93a, history information on the date prior to today. Alternatively, according to the input operation, the display control section 16 can control the display section 50b to end displaying the display-use history 93a.

(Flow of Process of Visit Determination by Mobile Terminal 1)

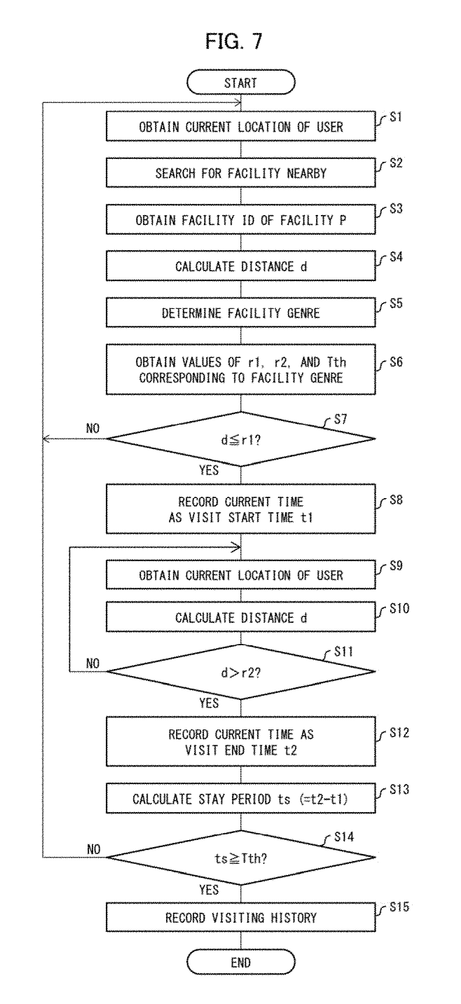

FIG. 7 is a flow chart illustrating a flow of steps S1 through S15 in the visit determination carried out by the mobile terminal 1. The flow of the process will be briefly described below. First, the facility ID obtaining section 11 obtains location information (information indicating the current location of a user) from the GPS receiving section 60 (S1, location information obtaining step).

Subsequently, the facility ID obtaining section 11 compares the location information with the facility database 91 to search for a facility in the vicinity of the user, and detects a facility P (visiting subject candidate facility) (S2). Then, the facility ID obtaining section 11 refers to the facility database 91 to obtain a facility ID of and the like of the facility P (S3).

Then, the distance calculating section 12 calculates a distance d (distance between the user and the facility P) by use of (i) the location information obtained in S1 and (ii) the information (facility location information) which indicates the location of the facility P and which was obtained in S2 (S4). Then, the facility genre determining section 13 compares the facility genre code of the facility P with the genre code correspondence table 92 to determine the facility genre of the facility P (S5).

Then, the facility genre determining section 13 obtains, from the genre code correspondence table 92, respective values of r1, r2, and Tth set for the facility genre thus determined (S6). That is, the facility genre determining section 13 sets the respective values of r., r2, and Tth according to the facility genre. In S6, the facility genre determining section 13 can further obtain a value of Tn from the genre code correspondence table 92.

The visit determining section 14 then (i) obtains the distance d from the distance calculating section 12 and (ii) obtains the current time t from the timer 61. Then, by use of r1 set by the facility genre determining section 13, the visit determining section 14 determines whether or not “d≤r1” is true (whether or not the above starting condition is satisfied) (S7, visit determining step). That is, the visit determining section 14 determines whether or not the location of the user C indicated by location information is included in a visit starting area D1.

In a case where “d≤r1” is true (YES in S7), the visit determining section 14 sets current time t (i.e., the time at which the starting condition is satisfied) as visit start time t1. This visit start time t1 can be expressed as time at which the location of the user C, indicated by location information, moves to a first location included in the visit starting area D1. The visit determining section 14 records the visit start time t1 in the storage section 90 (S8). In a case where “d>r1” is true (NO in S7), the process returns to S1.

After S8, the facility ID obtaining section 11 obtains location information again (S9, location information obtaining step). Then, the distance calculating section 12 re-calculate a distance d by use of (i) the location information obtained in S9 and (ii) the facility location information obtained in S2 (S10).

The visit determining section 14 then (i) obtains the distance d again from the distance calculating section 12 and (ii) obtains the current time t again from the timer 61. Then, by use of r2 set by the facility genre determining section 13, the visit determining section 14 determines whether or not “d>r2” is true (whether or not the above ending condition is satisfied) (S11, visit determining step).

That is, the visit determining section 14 determines whether or not the location of the user C indicated by the location information has changed (transitioned) so as to be at (i) the first location included in the visit starting area D1 and then (ii) a second location excluded from a visit ending area D2. That is, the visit determining section 14 determines whether or not the above spatial conditions are satisfied.

In a case where “d>r2” is true (YES in S11), the visit determining section 14 sets current time t (i.e., the time at which the ending condition is satisfied) as visit end time t2.

This visit end time t2 can be expressed as time at which the location of the user C, indicated by location information, moves to the second location excluded from the visit ending area D2. Then, the visit determining section 14 records the visit end time t2 in the storage section 90 (812). In a case where “d r2” is true (NO in S7), the process returns to S9.

After S12, the visit determining section 14 calculates a stay period ts where ts=t2−t1 (S13). Then, by use of Tth set by the facility genre determining section 13, the visit determining section 14 determines whether or not “ts≥Tth” is true (whether or not the above time condition is satisfied) (S14, visit determining step).

In a case where “ts≥Tth” is true (YES in S14), the visit determining section 14 determines that the user has made the visit to the facility P. Then, the record control section 15 writes, into the visiting history 93, history information indicating the record of the visit (S15). In a case where “ts<Tth” is true (NO in S13), the process returns to S1.

In S15, the record control section 15 writes (i) the date and time indicated by the visit start time t1 into the “visiting date and time” column in the visiting history 93, and (ii) the date and time indicated by the stay period ts into the “stay period” column in the visiting history 93. In addition, the record control section 15 writes the facility name of facility P into the “visited facility” column in the visiting history 93. The record control section 15 can write the facility ID of the facility P into the “visited facility” column of the visiting history 93 instead of (or in addition to) writing the facility name of the facility P.

Embodiment 1 demonstrated an example in which both the spatial conditions and the time condition are used to perform visit determination. Alternatively, time condition can be excluded from the visit determination. In such a case, the mobile terminal 1 can determine, in a case where spatial conditions are satisfied, that the user has made a visit to the facility P. From the viewpoint of improving the accuracy of visit determination, however, it is preferable to perform visit determination by further using a time condition.

(Effect of Mobile Terminal 1)

As described above, it is considered that movement patterns of a user are not necessarily similar between (i) a case where the user is moving from a facility P and (ii) a case where the user is moving toward the facility P. For example, the following patterns 1 and 2 are considered.

(Pattern 1): A pattern in which the user moves more quickly when moving away from the facility P than when moving toward the facility P. For example, the following case is considered: The user visits the facility P (stadium) to fulfilling a certain purpose (e.g., watching sports). In such a case, it is conceivable that the user would focus on leaving the facility P after fulfilling the purpose. It is therefore assumed that the user moves in the pattern 1.

(Pattern 2): A pattern in which the user moves more quickly when moving toward the facility P than when moving away from the facility P. Depending on the genre of the facility P or on the purpose of the user, it is conceivable that the user would focus on arriving quickly at the facility P in order to fulfill the purpose. In such a case, it is assumed that the user moves in the pattern 2.

In order to perform visit determination with higher accuracy than in the cases of conventional techniques, it is preferable to thus consider the differences in movement patterns of the user. Specifically, it is preferable to perform visit determination in view of the behavioral patterns of the user, which patterns reflect actual situations. Based on this point, the mobile terminal 1 in accordance with Embodiment 1 is configured so that the visit ending area D2 is set as an area which is different from the visit starting area D1. For example, according to Embodiment 1, the visit ending area D2 is set to be larger in size than the visit starting area D1 in view of the above pattern 1.

Note, however, that the visit ending area D2 can be set to be smaller in size than the visit starting area D1 in a case where it is preferable to consider the above pattern 2. That is, “r2<r1” can be set. Specifically, according to Embodiment 1, it is only necessary to set “r2≠r1” in the genre code correspondence table 92. The mobile terminal 1 can be thus configured so that the visit ending area ID2 and the visit starting area. D1 are set as different areas. This also applies to each of embodiments described later.

As described above, the mobile terminal 1 is configured to consider the difference in movement patterns of the user by setting the visit starting area D1 and the visit ending area D2 as different areas. That is, with the mobile terminal 1, it is possible to perform visit determination in view of the behavioral patterns of the user, which patterns reflect actual situations. It is therefore possible to perform visit determination with higher accuracy than in the cases of the conventional techniques.

Generally, it is considered that the movement patterns of user vary depending on the genre of the facility P. Therefore, the mobile terminal 1 is preferably configured so that the respective sizes of the visit starting area D1 and the visit ending area D2 (more specifically, the respective values of the visit starting radius r1 and the visit ending radius r2 described above) are set according to the genre of the facility P as described above.

With the above configuration, it is possible to set (change) the visit starting area D1 and the visit ending area D2 according to the genre of the facility P. Therefore, by use of the visit starting area D1 and the visit ending area D2 having respective suitable sizes, visit determination can be performed according to the genre of the facility P. This makes it possible to further improve the accuracy of visit determination.

The mobile terminal 1 can be configured so as to perform visit determination by use of a stay period threshold Tth. That is, in addition to spatial conditions (determination conditions concerning the respective sizes of the visit starting area D1 and the visit ending area D2), a time condition (determination conditions concerning time) can be further used to perform visit determination.

For example, in a case where the user has merely temporarily passed the facility P while traveling, the above stay period ts is relatively short. In a case where the stay period ts is thus relatively short, it is considered unlikely that the user intends to visit the facility P.

Therefore, by setting the stay period threshold Tth properly, it is possible to determine, in a case where “ts<Tth” is true (i.e., in a case where it is considered unlikely that the user intends to visit to the facility P), that the user is not making a visit to the visit P. That is, it is possible to reduce the possibility of making erroneous determination in the visit determination. Therefore, the accuracy of the visit determination can be further improved.

Generally, it is considered that stay periods of a user also vary depending on the genre of the facility P. It is therefore preferable to configure the mobile terminal 1 so that a stay period threshold Tth is set according to the genre of the facility P. With the configuration, it is possible to perform the visit determination by use of the stay period threshold Tth which is corresponds to the genre of the facility P. This allows the accuracy of the visit determination to be further improved.

In a case where the stay period ts is excessively long, it is conceivable that the user is staying in the facility P for a purpose other than a temporary visit (e.g., work). It is therefore considered preferable not to treat, as a visit to the facility P, such a stay for an extended period of time.

Based on this point, it is possible to further set a second stay period threshold Tth2 which is longer than the above stay period threshold Tth. In such a case, it is possible to configure the mobile terminal 1 so that the above time condition is set as “Tth≤ts<Tth2”. Specifically, in a case where a stay period ts is equal to or longer than a second stay period threshold Tth2 (in a case where the stay period ts is excessively long), the visit determining section 14 can determine that the user is not making a visit the facility P. Note that the second stay period threshold Tth2 is also preferably set according to the genre of the facility P.

It should be noted that although Embodiment 1 discussed an example in which the determination parameters are set for each genre of a facility. Note, however, that the determination parameters can be set for each facility. In such a case, it is only necessary to prepare, in advance, a table indicating correspondences between facility IDs and respective determination parameters. With the configuration, individual determination conditions for respective facilities can be used to perform visit determination even in a case where there are different facilities of same genre (e.g., amusement park). This also applies to each of the embodiments described later.

(Re-Determination Possible Period Threshold Tn)

Note that it is also conceivable that a user repeatedly visits the same facility within a certain time range (e.g., within 12 hours or within 24 hours). For example, in a case where the user makes a round trip on a certain path by train as described above, it is conceivable that the user would visit the same station in each of an outward trip and a return trip. In view of such a case, it is considered preferable not to treat a plurality of visits to the same facility within a certain time range as individual visits (separate one-time visits).

It is therefore possible to prevent, by use of the re-determination possible period threshold Tn shown in FIG. 4, the visit determining section 14 from performing visit determination on a visit(s) to a facility made within a certain time range from a time point at which visit determination on a visit to the same facility ended. For example, the following case is considered: The visit determining section 14 ends visit determination for the facility P and, as a result, visit end time is t2. Then, the visit determining section 14 starts visit determination for the facility P, and, as a result, visit start time is t1a.

In this case, the visit determining section 14 can abort the visit determination for the facility P in a case where “Tn≤t1a−t2” is true. That is, the visit determining section 14 can exclude the facility P from a target of visit determination until a time period longer than the re-determination possible period threshold Tn has elapsed since a time point at which the previous visit determination for the facility P ended. This configuration makes it possible that even in a case where a plurality of visits to a facility are made within a certain time range (within the re-determination possible period threshold Tn), it is possible not to treat, as the individual visits, a second visit and subsequent visits to the same facility.

[Variations]

It is possible to configure the visit determining section 14 so that even in a case where a plurality of visiting subject candidate facilities are detected by the facility ID obtaining section. 11, the visit determining section 14 performs the above-described visit determination. The following description will discuss an example in which two facilities, a facility P and a facility Q, are detected as visiting subject candidate facilities. Hereinafter, for convenience of explanation, a visit starting area and a visit ending area of the facility Q will be referred to as “visit starting area DQ1” and “visit ending area DQ2”, respectively.

From the viewpoint of avoiding the complication of the process of the visit determination, the areas are preferably set so that there is no overlapping between (i) the visit starting area D1 and visit ending area D2 of the facility P and (ii) the visit starting area DQ1 and visit ending area DQ2 of the facility Q.

Note, however, that there can be partial overlapping between (i) at least one of the visit starting area D1 and the visit ending area D2 of the facility P and (ii) at least one of the visit starting area DQ1 and the visit ending area DQ2 of the facility Q. For example, the following case is considered: The visit ending area D2 partially overlaps the visit starting area DQ1. In this case, the visit determining section 14 can perform, for example, any of the following two types of process.

(1): In a case where a user enters the visit starting area DQ1 and where remains in the visit ending area D2, the visit determining section 14 aborts visit determination for the facility P and start visit determination for the facility Q. In this case, the visit end time for the facility P matches the visit start time for the facility Q.

(2): In a case where a user remains in the visit ending area D2 and where enters the visit starting area DQ1, the visit determining section 14 continues visit determination for the facility P and does not perform visit determination for the facility Q.

### Embodiment 2

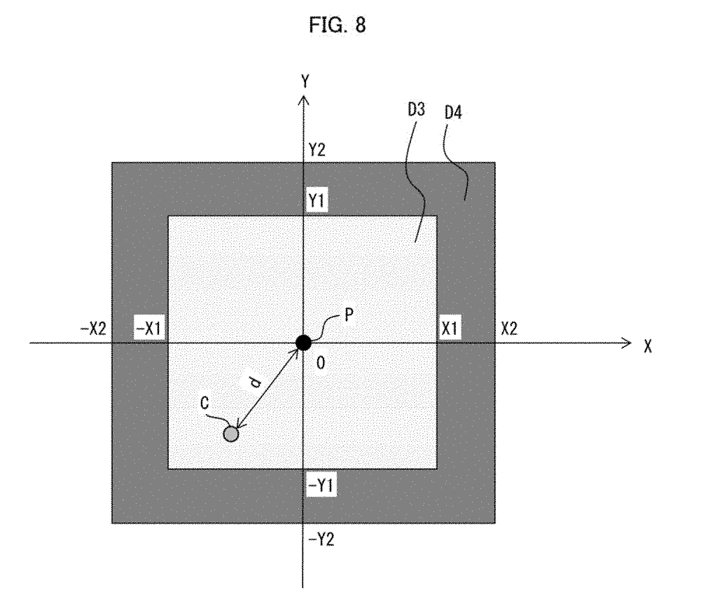

The following description will discuss Embodiment 2 of present invention with reference to FIG. 8. For convenience, members which are identical in function to the members described in the previous embodiments will be given respective identical reference signs, and descriptions of those members will be omitted.

Embodiment 1 discussed an example in which the visit starting area D1 and the visit ending area D2 are each a circular area. According to the mobile terminal 1, however, the shape of each area is not limited to a circular shape. Embodiment 2 will discuss another example of the shape.

FIG. 8 is a view illustrating a visit starting area D3 (visit starting zone) and a visit ending area D4 (visit ending zone) in Embodiment 2. As illustrated in FIG. 8, each of the visit starting area D3 and the visit ending area D4 is rectangular region. In FIG. 8, an X-axis is an axis indicating the latitude, and a Y-axis is an axis indicating the longitude. The origin of the X-Y coordinates of FIG. 8 is set to the location of a facility P.

As illustrated in FIG. 8, the visit starting area D3 is a rectangle having four points of (X1, Y1), (−X1, Y1), (−X1, −Y1), and (X1, −Y1) as vertexes. The visit ending area D4 is a rectangle having four points: (X2, Y2), (−X2, Y2), (−X2, −Y2), and (X2, −Y2) as vertexes. Note that X1, X2, Y1, and Y2 are all positive values.

X1 and Y1 can be referred to as “visit starting latitude” and “visit starting longitude”, respectively. X2 and Y2 can also be referred to as “visit ending latitude” and “visit ending longitude”, respectively. According to Embodiment 2, X1, X2, Y1, and Y2 are set for each facility genre code (for each facility genre) in a genre code correspondence table 92.

With the visit starting area D3 and D4 in FIG. 8, a starting condition according to Embodiment 2 (i.e., a condition indicating that a user C has entered the visit starting area D3), is represented as follows.

dssqrt{(X1\hat{ }2+Y1\hat{ }2)}

In addition, an ending condition according to Embodiment 2 (i.e., a condition indicating that the user C has exited the visit ending area D4), is represented as follows.

d>sqrt{(X2\hat{ }2+Y2\hat{ }2)}

Even in a case where the rectangular visit starting area D3 and the rectangular visit ending area D4 are thus used, the visit determination for the facility P can be performed as in Embodiment 1. Embodiment 2 therefore brings about an effect similar to that of Embodiment 1.

Note that the shapes of building structures (e.g., buildings) are relatively often represented as substantially rectangular shapes in two-dimensional maps. In view of this point, depending on the type of the facility P, there can be cases where the visit starting area D3 and the visit ending area D4 (rectangular areas) of Embodiment 2 are preferable to the visit starting area D1 and the visit ending area D2 (circular areas) of Embodiment 1.

In addition, with the visit starting area D3 and the visit ending area D4, it is only necessary to perform calculation on the X-Y coordinates (orthogonal coordinates). Specifically, unlike Embodiment 1, it is unnecessary to perform calculation by use of radiuses. Since calculation by use of radiuses (e.g., calculation on circular coordinates) can be relatively complicated, Embodiment 2 can also simplify the process of the control section 10.

Therefore, depending on how the mobile terminal 1 is to be used, it is thus possible to use (i) a circular visit starting area and a circular visit ending area or (ii) a rectangular visit starting area and a rectangular visit ending area.

The mobile terminal 1 is configured so that the shapes of a visit starting area and a visit ending area are not limited to those described above. The shape of each area can be, for example, ellipsoidal or polygonal (e.g., triangular shape or pentagonal shape). A visit starting area and a visit ending area can have any shapes, provided that the visit starting area and the visit ending area are set as different areas. The shape of each area need only be a shape with which it is possible to define a closed region including the coordinates of the facility P on the map. This also applies to Embodiment 3 described later.

### Embodiment 3

Each of the above embodiments discussed an example in which a two-dimensional (planar) visit starting area and a two-dimensional (planar) visit ending area are defined by the latitude and longitude. Note, however, that the mobile terminal 1 can be configured so that a visit starting area and a visit ending area are set as three-dimensional (stereoscopic) areas. Specifically, in addition to the latitude and longitude, a height can be further considered in order to define a visit starting area and a visit ending area. The “size” of each area in Embodiment 3 means a volume.

For example, the following case is considered: A facility P is a restaurant located on the highest floor of a tall building. In this case, a visit starting area can be a sphere which has a radius (visit starting radius) r3 and in which the facility P is the center. In addition, a visit ending area can be a sphere which has a radius (visit ending radius) r4 and in which the facility P is the center. In such a case, r3 and r4 can be set for each facility genre code (for each facility genre) in a genre code correspondence table 92.

As described above, a visit starting area and a visit ending area can be set as different areas. That is, it is only necessary to set “r3≠r4”. In a case where “r3<4” is true, a visit starting area can be set to be smaller in size than a visit ending area. In contrast, in a case where “r3>r4” is true, the visit starting area can be set to be larger in size than the visit ending area.

Even in a case where a three-dimensional visit starting area and a three-dimensional visit ending area are used, the shape of each area is, as described above, not limited to any particular one. For example, the shape of each area can be any three-dimensional shape such as a spheroid, a column, a polyhedron (e.g., rectangular parallelepiped), a cone, or a frustum.

In a case where visit determination is performed by use of a three-dimensional visit starting area and a three-dimensional visit ending area, the above-described location information and the facility location information need be information (e.g., three-dimensional space coordinates) indicating the location on three-dimensional space. The three-dimensional space coordinate system can be any coordinate system such as an orthogonal coordinate system, a cylindrical coordinate system, or a spherical coordinate system.

For example, in a case where a GPS receiving section 60 has a three-dimensional positioning function, a facility ID obtaining section 11 can obtain location information as three-dimensional space coordinates from the GPS receiving section 60. In such a case, facility location information, which is recorded in a facility database 91, can be recorded as three-dimensional space coordinates indicating the location of the each facility.

Note, however, that even in a case where the GPS receiving section 60 does not have the three-dimensional positioning function (i.e., a case where the GPS receiving section. 60 has only the two-dimensional positioning function), it is possible to control the facility ID obtaining section 11 to estimate a coordinate in a height direction.

For example, in a case where the mobile terminal 1 is provided with a pressure sensor (barometer), the facility ID obtaining section 11 can estimate (calculate) a height (altitude) h of the current location of a user, based on a value (pressure Ps) measured by the pressure sensor. For example, in a case where a certain formula (conversion formula) indicating a relationship between the pressure Ps and the height h is defined in advance in the facility ID obtaining section 11, the height h can be calculated according to the pressure Ps by use of the conversion formula.

In addition, depending on the type of the facility P, information indicating the height (e.g., information indicating the number of floors of a building) may be provided by an administrator of the facility P as, for example, a wireless signal. In such a case, the facility ID obtaining section 11 can determine the height of the current location of the user by obtaining such information indicating the height.

[Variations]

Note that in the process of visit determination carried out by the mobile terminal 1, it is preferable that a facility to be determined as “a facility visited by a user” (hereinafter referred to as “visiting subject facility”) is a facility which allows the user to recognize that the visit has been made. For example, determination conditions of the visit determining section. 14 are preferably set so that a facility (e.g., a store on a moving route) through which a user temporarily passes is not determined as a visiting subject facility.

In addition, in view of the privacy of the user, it can be considered preferable to exclude a certain facility/facilities from visiting subject facilities. Therefore, a facility/facilities to which a certain facility genre code(s) or a certain facility ID(s) is/are assigned can be excluded from the visiting subject facilities.

### Software Implementation Example

Control blocks of the mobile terminal 1 (particularly, the control section 10) can be realized by a logic circuit (hardware) provided in an integrated circuit (IC chip) or the like or can be alternatively realized by software as executed by a central processing unit (CPU).

In the latter case, the mobile terminal 1 includes a CPU that executes instructions of a program that is software realizing the foregoing functions; a read only memory (ROM) or a storage device (each referred to as “storage medium”) in which the program and various kinds of data are stored so as to be readable by a computer (or a CPU); and a random access memory (RAM) in which the program is loaded. An object of the present invention can be achieved by a computer (or a CPU) reading and executing the program stored in the storage medium. Examples of the storage medium encompass “a non-transitory tangible medium” such as a tape, a disk, a card, a semiconductor memory, and a programmable logic circuit. The program can be made available to the computer via any transmission medium (such as a communication network or a broadcast wave) which allows the program to be transmitted. Note that an aspect of the present invention can also be achieved in the form of a computer data signal in which the program is embodied via electronic transmission and which is embedded in a carrier wave.

[Recap]

An information processing device (mobile terminal 1) in accordance with Aspect 1 of the present invention includes: a location information obtaining section. (facility ID obtaining section 11) configured to obtain location information which indicates a location of a user (C); and a visit determining section (14) configured to determine whether or not the user has made a visit to a facility (P), the visit determining section being configured so that in a case where the location of the user indicated by the location information has changed from a first location to a second location, the visit determining section determines that the user has made the visit to the facility, the first location being included in a visit starting zone (visit starting area D1) which is preset, the second location being excluded from a visit ending zone (visit ending area. D2) which is preset, and the visit starting zone and the visit ending zone being different.

As described above, in order for determination (visit determination) of whether or not a user has made a visit to the facility to be performed with higher accuracy than the cases of the conventional techniques, it is preferable to consider a difference in movement patterns of the user between (i) a case where the user moves away from the facility and (ii) a case where the user moves toward the facility.

Based on this point, the information processing device in accordance with an aspect of the present invention is configured as described above so that the visit starting zone and the visit ending zone are set different zones (areas). This allows the visit determining section to perform visit determination in view of the difference in movement patterns. It is therefore possible to perform visit determination with higher accuracy than in the cases of the conventional techniques.

In Aspect 2 of the present invention, the information processing device in accordance with Aspect 1 is preferably configured so that: in a case where a stay period (ts) is shorter than a stay period threshold (Tth) which is preset, the visit determining section determines that the user has not made the visit to the facility, where the stay period is a difference between visit start time (t1) and visit end time (t2), the visit start time is time at which the location of the user indicated by the location information moves to the first location included in the visit starting zone, and the visit end time is time at which the location of the user indicated by the location information moves to the second location excluded from the visit ending zone.

In a case where a stay period ts is thus relatively short, it is considered unlikely that the user intends to visit the facility. The above configuration makes it possible that in a case where the stay period is shorter than the stay period threshold (i.e., in a case where it is considered unlikely that the user intends to visit the facility), it is determined that the user is not making a visit to the facility. Therefore, the accuracy of the visit determination can be further improved.

In Aspect 3 of the present invention, the information processing device in accordance with Aspect 2 is preferably configured to further include: a determination condition setting section (facility genre determining section 13) configured to set at least one of the visit starting zone, the visit ending zone, and the stay period threshold for each of facilities.

With the above configuration, at least one of the visit starting zone, the visit ending zone, and the stay period threshold can be set according to the facility. That is, the visit determination can be performed according to the facility. Therefore, the accuracy of the visit determination can be further improved.

In Aspect 4 of the present invention, the information processing device in accordance with any one of Aspects 1 through 3 can be configured so that the visit starting zone is larger in size than the visit ending zone.

As described above, as an example of the movement pattern of the user, the following pattern is conceivable: A pattern in which the user moves more quickly when moving away from the facility than when moving toward the facility (i.e., the pattern 1 described above). With the above configuration, it is possible to perform the visit determination in view of the movement pattern.

In Aspect 5 of the present invention, the information processing device in accordance with any one of Aspects 1 through 3 can be configured so that the visit starting zone is smaller in size than the visit ending zone.

As described above, as another example of the movement pattern of the user, the following pattern is conceivable: A pattern in which the user moves more quickly when moving toward the facility than when moving away from the facility (i.e., the pattern 2 described above). With the above configuration, it is possible to perform the visit determination in view of the movement pattern.

In Aspect 6 of the present invention, the information processing device in accordance with any one of Aspects 1 through 5 is preferably configured to further include: a record control section (15) configured to update a visiting history (93) in a case where the visit determining section has determined that the user has made the visit to the facility, the visiting history being a record of the user visiting the facility. With the above configuration, it is possible to automatically update the visiting history. This allows for an improvement in convenience of the user.

In Aspect 7 of the present invention, the information processing device in accordance with Aspect 6 is preferably configured to further include: a display control section (16) configured to control a display section (50b) to display an image (IMG) of at least part of the visiting history. With the above configuration, it is possible to visually notify, by the display section, the user of the content of the visiting history. That is, the user can easily confirm the content of the visiting history.

An information processing device controlling method in accordance with Aspect 8 of the present invention includes the steps of: (a) obtaining location information which indicates a location of a user; and (b) determining whether or not the user has made a visit to a facility, the step (b) further including the step of determining, in a case where the location of the user indicated by the location information has changed from a first location to a second location, that the user has made the visit to the facility, the first location being included in a visit starting zone which is preset, the second location being excluded from a visit ending zone which is preset, and the visit starting zone and the visit ending zone being different. The above configuration brings about an effect similar to that of the information processing device in accordance with an aspect of the present invention.

The information processing device according to the foregoing embodiments of the present invention may be realized by a computer. In this case, the present invention encompasses: a control program for the information processing device which program causes a computer to operate as the foregoing sections (software elements) of the information processing device so that the information processing device can be realized by the computer; and a computer-readable storage medium storing the control program therein.

[Additional Remarks]

The present invention is not limited to the embodiments, but can be altered by a skilled person in the art within the scope of the claims. The present invention also encompasses, in its technical scope, any embodiment derived by combining technical means disclosed in differing embodiments. Further, it is possible to form a new technical feature by combining the technical means disclosed in the respective embodiments. Further, it is possible to form a new technical feature by combining the technical means disclosed in the respective embodiments.

### REFERENCE SIGNS LIST

1 Mobile terminal (information processing device)
11 Facility ID obtaining section (location information obtaining section)
13 Facility genre determining section (determination condition setting section)
14 Visit determining section
15 Record control section
16 Display control section
50b Display section
93 Visiting history
C User
IMG, IMG1, IMG2, IMG3 Image
P Facility
D1, D3 Visit starting area (visit starting zone)
D2, 1D4 Visit ending area (visit ending zone)
t1 Visit start time
t2 Visit end time
ts Stay period
Tth Stay period threshold

1. An information processing device comprising:
a location information obtaining section configured to obtain location information which indicates a location of a user; and
a visit determining section configured to determine whether or not the user has made a visit to a facility,
the visit determining section being configured so that in a case where the location of the user indicated by the location information has changed from a first location to a second location, the visit determining section determines that the user has made the visit to the facility,
the first location being included in a visit starting zone which is preset,
the second location being excluded from a visit ending zone which is preset, and
the visit starting zone and the visit ending zone being different.

2. The information processing device as set forth in claim 1, wherein:
in a case where a stay period is shorter than a stay period threshold which is preset, the visit determining section determines that the user has not made the visit to the facility, where
the stay period is a difference between visit start time and visit end time,
the visit start time is time at which the location of the user indicated by the location information moves to the first location included in the visit starting zone, and
the visit end time is time at which the location of the user indicated by the location information moves to the second location excluded from the visit ending zone.

3. The information processing device as set forth in claim 2, further comprising:
a determination condition setting section configured to set at least one of the visit starting zone, the visit ending zone, and the stay period threshold for each of facilities.

4. The information processing device as set forth in claim 1, wherein
the visit starting zone is larger in size than the visit ending zone.

5. The information processing device as set forth in claim 1, wherein
the visit starting zone is smaller in size than the visit ending zone.

6. The information processing device as set forth in claim 1, further comprising:
a record control section configured to update a visiting history in a case where the visit determining section has determined that the user has made the visit to the facility,
the visiting history being a record of the user visiting the facility.

7. The information processing device as set forth in claim 6, further comprising:
a display control section configured to control a display section to display an image of at least part of the visiting history.

8. A method of controlling an information processing device, comprising the steps of:
(a) obtaining location information which indicates a location of a user; and
(b) determining whether or not the user has made a visit to a facility,
the step (b) further including the step of
determining, in a case where the location of the user indicated by the location information has changed from a first location to a second location, that the user has made the visit to the facility,
the first location being included in a visit starting zone which is preset,
the second location being excluded from a visit ending zone which is preset, and
the visit starting zone and the visit ending zone being different.

9. A control program for causing a computer to serve as an information processing device recited in claim 1, the control program causing the computer to serve as the location information obtaining section and the visit determining section.
